(19) United States
(12) Patent Application Publication
(10) Pub. No.: US 2025/0362056 A1
(43) Pub. Date: Nov. 27, 2025

(54) BOILER, IN PARTICULAR A CONDENSING BOILER, COMPRISING A HEAT EXCHANGER

(71) Applicant: RIELLO S.P.A., Legnago (IT)

(72) Inventors: Marco De Nardis, Legnago (IT); Diana Di Marco, Legnago (IT); Stefano Lambrughi, Legnago (IT)

(21) Appl. No.: 18/873,827

(22) PCT Filed: Jun. 26, 2023
(86) PCT No.: PCT/IT2023/050151

§ 371 Date: Dec. 11, 2024

(30) Foreign Application Priority Data
Jun. 27, 2022 (IT) 102022000013435

(51) Int. Cl. F24H 1/43; F24H 1/44; F28D 7/02

(52) U.S. Cl. CPC F24H 1/43; F24H 1/445; F28D 7/022; F24H 2210/00

(57) ABSTRACT

The present invention concerns a boiler, in particular a condensing boiler, said boiler comprising at least one combustion zone, and a burner arranged in correspondence with said combustion zone along a longitudinal axis, and at least one first heat exchanger adapted to encircle said burner with its internal portion facing towards said burner and directly exposed to the flame of said burner, when in use, said heat exchanger providing a steel duct, preferably stainless steel, having a spiral profile and comprising a plurality of coils having a common axis of symmetry, the axis of symmetry of said first heat exchanger coinciding with said longitudinal axis of the boiler, said boiler being characterised in that the internal portion facing towards said axis of symmetry of each coil of said first heat exchanger has a continuous depression along at least one portion of said spiral profile.

The present invention concerns a boiler, in particular a condensing boiler.

More precisely, the present invention concerns a boiler comprising a heat exchanger having a particular tube profile.

In the state of the art, heat exchangers for condensing boilers are known which have a serpentine pattern.

Examples are described in the following patent titles EP 2 504 632 B1 or WO 2016/084109 A1 concerning heat exchangers for condensing boilers comprising double serpentine circuits, in particular an internal circuit and an external one.

In both of said known solutions, the outer surface of each coil S of the innermost exchanger, facing towards the burner of the condensing boiler, has a smooth and slightly convex surface (as shown in FIG. 4), with the convexity C facing towards the burner.

A drawback of such geometric shape is that in correspondence with the portion of the heat exchanger facing towards the burner flame it is more subject to corrosion, due to the phenomenon of material flaking.

Such a phenomenon is typical of stainless steels subject to high-temperature oxidation.

When stainless steels are brought to high temperatures, an oxide and scale layer forms on the surface of the material.

The scale and the metal substrate have different thermal expansions which will affect the stability of the oxide scale, especially if the material is subjected to frequent thermal cycles. Due to the different coefficients of thermal expansion, excess scale will form which will eventually shatter or break as the metal cools. This phenomenon is cyclic, the surface will locally become thinner and thinner, leading then to the formation of a crack and therefore to the breaking of the material.

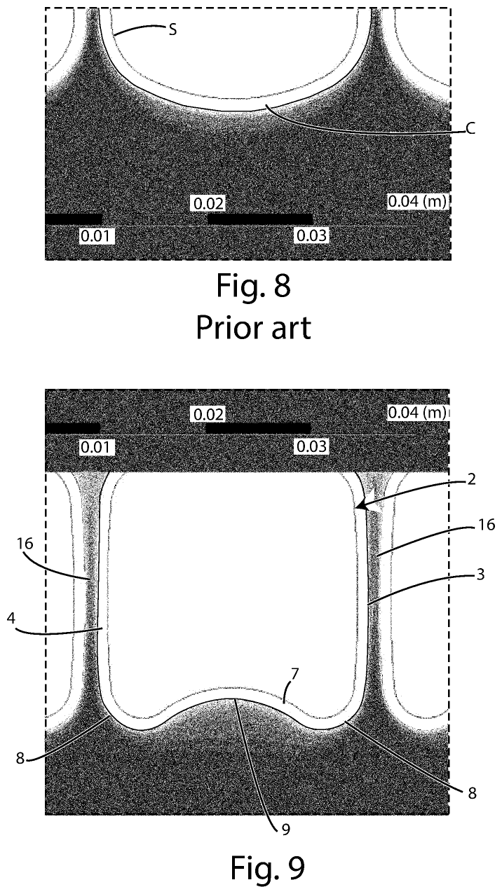

Again another drawback of such prior art geometric shape is that the internal wall of each coil of the internal heat exchanger generally has a relatively cold temperature, as shown in FIG. 8 (generally between 30° and 90° C.) compared to the temperature of the flame of the burner 11 (which is around 1600° and 2000° C.), abruptly interrupting the process of oxidation of the carbon monoxide to carbon dioxide as soon as the combustion fumes reach such wall. Therefore, a large number of polluting agents are produced.

The aim of the present invention is to solve the prior art drawbacks.

In particular, an aim is to reduce, if not eliminate, the phenomenon of the formation of flaking of the material which makes up the surface of the exchanger in the combustion zone, in correspondence with the burner.

A further aim of the present invention is to reduce the number of polluting agents produced by the combustion process.

An object of the present invention is a heat exchanger for a boiler, in particular a condensing boiler, said boiler comprising at least one combustion zone, and a burner arranged in correspondence with said combustion zone along a longitudinal axis, said heat exchanger being adapted to encircle said burner of said boiler when inserted in said boiler, said heat exchanger providing a steel conduit, preferably stainless steel, having a spiral profile and comprising a plurality of coils having a common axis of symmetry, said heat exchanger being characterised in that the internal portion facing towards said axis of symmetry of each coil has a continuous depression along at least one portion of said spiral profile.

In particular, according to the invention, the cross section of the conduit of each coil can have a concavity defined between two inflection points arranged at the internal portion of said coil.

More specifically, according to the invention, the depth of said concavity can be between 4% and 50% of the width of the cross section of the conduit of the respective coil.

Again, according to the invention, the height of said concavity can be between 43% and 81% of the height of the cross section of the conduit of the respective coil, wherein the height of the concavity is measured as the distance between said two inflection points.

Still according to the invention, the cross section of said conduit of each coil can have two opposite and parallel sides, which are substantially transverse to said axis of symmetry, such as to form a plurality of parallel channels between adjacent coils.

Further according to the invention, the cross section of the conduit of each coil can be circular, triangular or quasi-pentagonal and can have an internal side comprising said concavity.

Furthermore, it is an object of the present invention a boiler comprising at least one combustion zone, a burner arranged in correspondence with said combustion zone along a longitudinal axis, and a first heat exchanger as previously described, said first heat exchanger encircling said burner, the axis of symmetry of said first heat exchanger coinciding with said longitudinal axis of the boiler, said boiler being characterised in that the internal portion facing towards said burner of each coil of said first heat exchanger has said continuous depression along said spiral profile at least in correspondence with said combustion zone.

In particular, according to the invention, said boiler can comprise a second heat exchanger which provides a conduit having a spiral profile and comprising a plurality of coils whose axis of symmetry coincides with said longitudinal axis, the coils of said second heat exchanger having a greater radius than the radius of the coils of the first heat exchanger so as to encircle it externally.

More particularly, according to the invention, each coil of the second heat exchanger can be arranged between two coils of the first heat exchanger so as to mutually interpenetrate and form additional channels for the passage of the combustion fumes.

Preferably according to the invention, the cross section of said conduit of each coil of said first heat exchanger and of said second heat exchanger can have an edge having an acute angle between 30° and 90°, preferably equivalent to 90°, said edge of each coil of each heat exchanger facing towards the gap between two adjacent coils of the other heat exchanger.

Furthermore, according to the invention, the cross section of the conduit of each coil of the second heat exchanger can have the same shape as the cross section of the conduit of each coil of the first heat exchanger mirrored with respect to an imaginary plane parallel to said longitudinal axis.

Finally, according to the invention, said boiler can be a condensing boiler comprising an adjacent condensation zone along said axis longitudinal to said combustion zone and separated therefrom by an internal separation part.

The invention will now be described for illustrative but non-limiting purposes, with particular reference to the drawings of the attached figures, wherein:

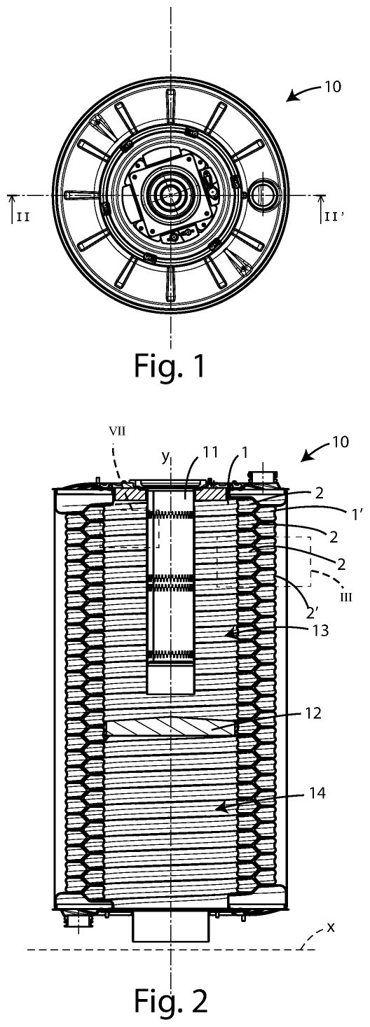

FIG. 1 shows a top view of a condensing boiler comprising a pair of spiral heat exchangers according to the invention;

FIG. 2 shows a cross-sectional view along the plane II-II′ of the condensing boiler of FIG. 1;

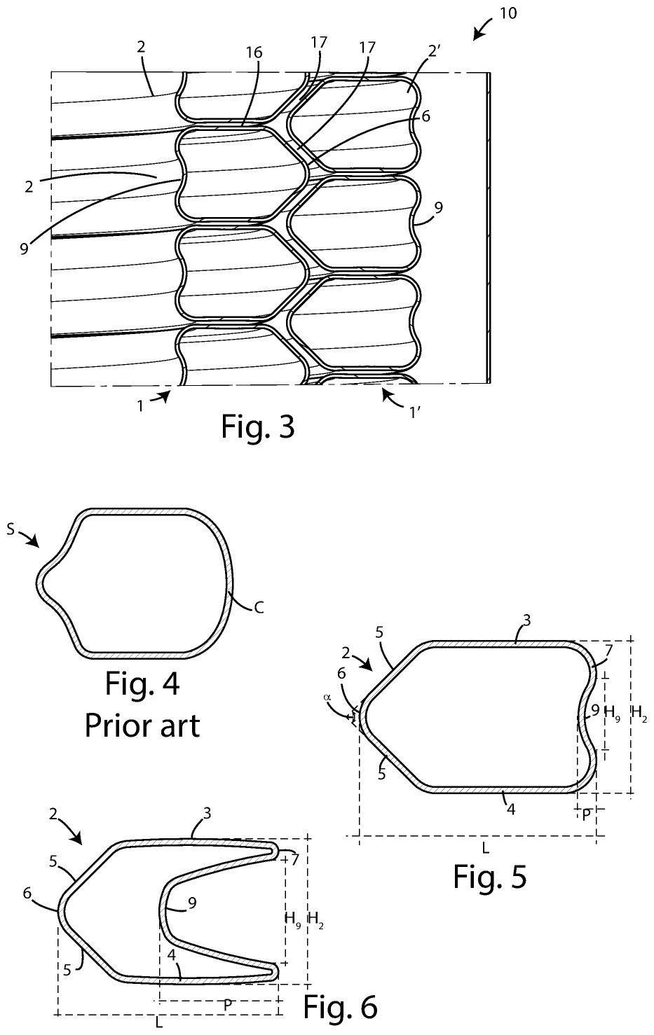

FIG. 3 shows detail III of FIG. 2;

FIG. 4 shows a cross-sectional view of a prior art heat exchanger conduit;

FIG. 5 shows a cross-sectional view of the conduit of one of the two heat exchangers of the condensing boiler of FIG. 1;

FIG. 6 shows a cross-sectional view of a heat exchanger conduit according to the invention in a second variant;

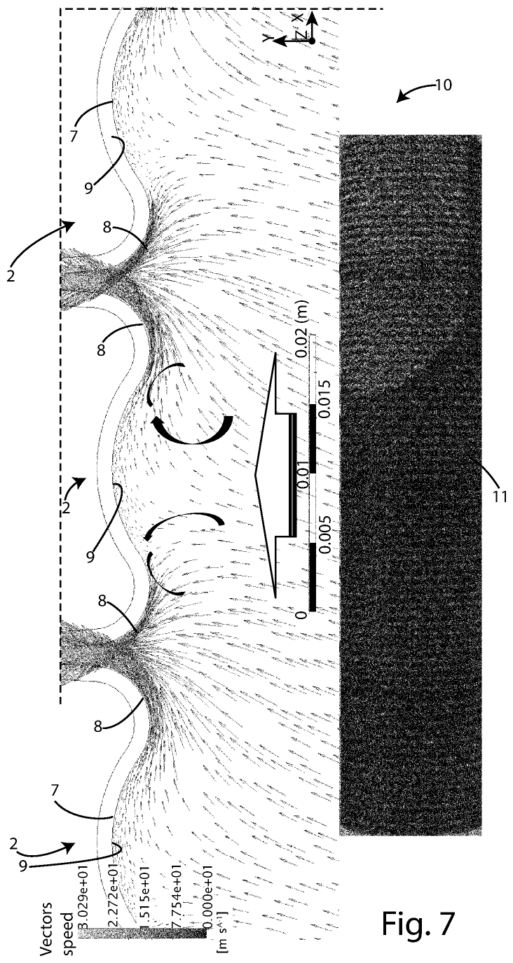

FIG. 7 shows the detail VII of FIG. 2 wherein the dynamics of the fluxes of the combustion gases are shown in correspondence with the combustion zone;

FIG. 8 shows a cross-sectional view of a detail of a prior art heat exchanger having conduits like that of FIG. 4, wherein different thermal zones are shown;

FIG. 9 shows a cross-sectional view of the heat exchanger of FIG. 1, wherein different thermal zones are shown;

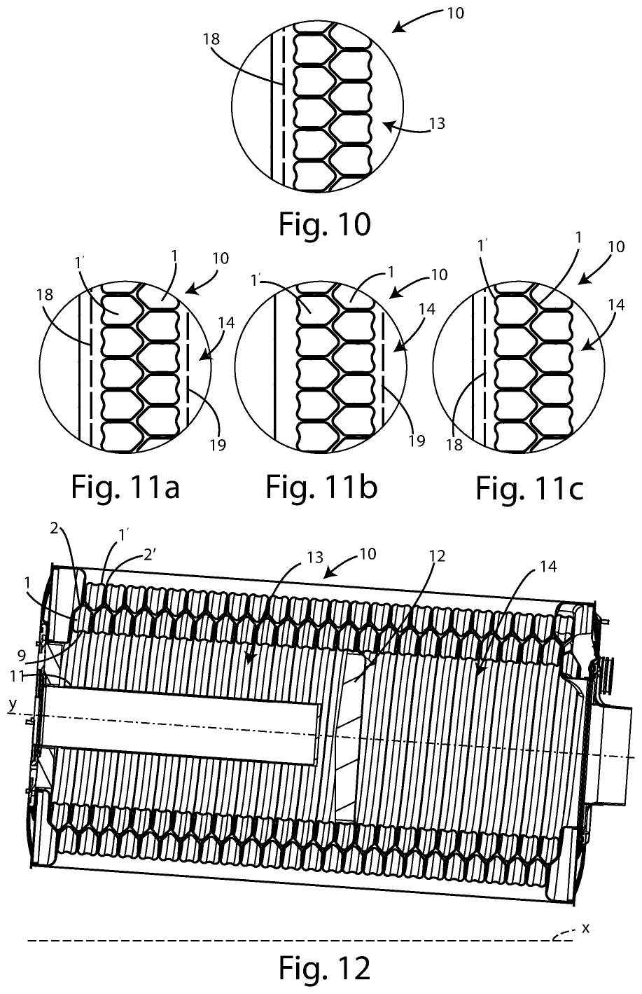

FIG. 10 shows a cross-sectional view of the condensing boiler according to the invention in correspondence with the combustion zone in a first embodiment variant;

FIGS. 11a-11c each show a cross-sectional view of the condensing boiler according to the invention in correspondence with the condensation zone according to three different embodiments; and

FIG. 12 shows a cross-sectional view of a condensing boiler according to the invention in a further embodiment.

Referring to FIGS. 1 and 2, a condensing boiler 10 can be seen comprising a pair of heat exchangers 1, 1′ according to the invention in a preferred embodiment.

The condensing boiler 10 also provides a burner 11 arranged in correspondence with the combustion zone 13, an internal separation wall 12 arranged between the combustion zone 13 and the condensation zone 14.

Each heat exchanger 1, 1′ is adapted for the passage of a heat transfer fluid to be heated through heat exchange with the condensation fluids in correspondence with the condensation zone 14 and with the combustion fumes in correspondence with the combustion zone 13.

In particular, each heat exchanger 1, 1′ has a spiral pattern and one 1′ is concentric with respect to the other 1. Said heat exchangers 1, 1′ have their axis of symmetry coinciding with the longitudinal axis y of symmetry of the boiler 10. In particular, said longitudinal axis y being a vertical axis arranged in a vertical direction with respect to an apparent horizontal support plane x.

In other embodiments, such as the one shown in FIG. 12, the axis of symmetry y of the boiler 10 can be oriented transversally to a vertical axis, in other words it can have the axis of symmetry y substantially parallel to the horizontal support plane x or slightly inclined to it. For example, by an angle of 4°, as in FIG. 12.

Each heat exchanger 1, 1′ comprises a conduit having a spiral profile. Said conduit is made of steel, preferably stainless steel.

In particular, a first spiral heat exchanger 1 can be seen comprising a plurality of coils 2 and having the internal portion 7 of each coil 2 facing towards the burner 11. The second spiral heat exchanger 1′ also comprises a plurality of coils 2′ and has a greater radius than the first heat exchanger 1 so as to circumscribe it externally.

Furthermore, each coil 2, 2′ of each heat exchanger 1, 1′ has a cross section of quasi-pentagonal shape, as shown in particular in FIGS. 3 and 5. Specifically, quasi-pentagonal shape means a geometric figure having five sides, where however the sides and the angles between the sides are not necessarily all identical.

In particular, as shown by way of example in FIG. 5 for the coils of both the first 1 and the second 1′ heat exchanger, the quasi-pentagonal section has a first side 3 and a second side 4 opposite to each other which are substantially parallel to each other and substantially transverse to the longitudinal axis y. Furthermore, the quasi-pentagonal section of each coil 2 has a third side 7 for joining the two opposite sides 3 and 4 and, in the position opposite to said third side 7, it has two inclined sides 5 which form an edge 6 having an acute angle α. Said acute angle α being between 30° and 90°, preferably in the embodiment of FIG. 5 it is equivalent to 90°.

In each spiral heat exchanger 1 between the first 3 and the second 4 side of adjacent coils 2 of the same exchanger 1 a channel 16 is formed for the passage of the combustion fumes in correspondence with the combustion zone 13 or for the passage of the condensing liquids in correspondence with the condensation zone 14. The fact that the first and second sides 3, 4 of each coil 2 are parallel makes it possible to obtain a better heat exchange. In other embodiments, however, they may not even be parallel.

Furthermore, when the two spiral exchangers 1, 1′ are placed side by side, they are arranged with the edges 6 of the respective coils 2, 2′ facing towards the edges 6 of the coils 2′, 2 of the other spiral exchanger 1′, 1 and so as to fit between the inclined sides 5 of two side-by-side coils 2 of the same spiral exchanger 1, as shown in FIG. 3, so as to interpenetrate.

In this way the two spiral exchangers 1, 1′ concentric with each other are particularly compact and form additional channels 17 for the passage of the combustion fumes or condensing liquids.

Finally, still observing FIG. 5, in correspondence with the third side 7, a concavity 9 is obtained, which forms a depression 9 along the entire wall of the third side 7 of the coil 2.

Therefore, each spiral exchanger 1 has a continuous depression 9 along its entire wall in correspondence with the respective third side 7 which follows the spiral profile of the exchanger 1.

In particular, in the first heat exchanger 1 the depression 9 is facing towards the internal portion of the condensing boiler 10. In the combustion zone 13, such depression 9 is facing towards the burner 11 directly exposed to the flame of the burner 11, when the boiler 10 is in use.

This depression 9 is obtained by mechanical machining of a tube profile which initially has said third convex side 7 (as for example in the prior art of FIG. 4), obtaining the concavity 9 shown in the figures.

The depth P of the concavity 9 is preferably 4% of the width L of the coil 2.

In other embodiments the depth P of the concavity 9 can be between 4% and 50% of the width L of the coil 2 as in the following formula:

$$4 \% \leq \frac{P}{L} \leq 50 \% .$$

FIG. 6 shows a variant of the coil 2 according to the invention wherein the depth P of the concavity 9 is equivalent to 50% of the width L of the coil 2.

Furthermore, the height H₉ of the concavity 9 is substantially 61% of the height H₂ of the coil 2.

The height H₉ of the concavity 9 is measured as the distance between the inflection points of the concavity 9 arranged in correspondence with the third side 7.

In other embodiments the height H₉ of the concavity 9 can be between 43% and 81% of the height H₂ of the coil 2 as in the following formula:

$$43 \% \leq \frac{{H}_{9}}{{H}_{2}} \leq 81 \% .$$

For example, in the variant of FIG. 6 the height H₉ of the concavity 9 is substantially 81% of the height H₂ of the coil 2.

In the second heat exchanger 1′ the depression 9 is instead facing towards the outside of the condensing boiler 10. In other embodiments the second heat exchanger 1′ may not have said depression.

Again, in other embodiments the first heat exchanger 1 can have the depression 9 continuous along its spiral profile only in correspondence with the combustion zone 13.

The depression 9 obtained in each coil 2 of the first heat exchanger 1 in correspondence with the combustion zone 13 advantageously allows an improvement in the reliability of the product. The internal portion 7 of the coils 2 of the first heat exchanger 1 directly exposed to the flame of the burner 11 is in a state of compression and this gives greater resistance to corrosion. In this way the phenomenon of material flaking is counteracted, prolonging the product life.

Furthermore, thanks to the presence of the concavity 9 in correspondence with the third side 7 of each coil 2 of the first heat exchanger 1, an improvement in combustion is advantageously obtained, as exemplified in FIG. 7. The concave shape 9 of the surface of the third side 7 makes it possible to create a zone of stagnation or recirculation of the combustion gases, as shown in FIG. 9. The flame of the burner 11 moves away from the cold wall of the tube 2 of the first exchanger 1 and the combustion is completed in a clean way: in fact, the oxidation of the carbon monoxide to carbon dioxide is not interrupted by the direct contact with the wall of the tube 2, the presence of the concavity 9 therefore makes it possible to have a longer path of the combustion flow, slowing down the CO to CO₂ oxidation process.

Such a phenomenon is particularly clear from the comparison of FIGS. 8 and 9 where, in grey scale, the darker colour shows the temperature of the combustion gases coming from the burner 11, and the gradually lighter gradient colours show the zones where the temperature cools towards the surface of the coil tube 2.

In particular, in the diagrams of FIGS. 8 and 9 the zones indicate the following average temperatures:
darker coloured zone: average T°=1700° C.;
next zone: average T°=1400° C.;
next zone: average T°=950° C.;
next zone: average T°=440° C.; and
lighter coloured zone: average T°=100° C.

As can be seen in the solution according to the invention, thanks to the concavity 9, the lower temperature zone is further away from the burner 11 compared to the prior art solution shown in FIG. 8. Therefore, the material directly exposed to the flame is in a state of compression (the oxide is subject to compressive stresses, therefore it tends to adhere to the surface) and this gives greater resistance to corrosion.

The greater the surface of the concavity 9 facing towards the flame of the burner 11, the greater the benefits of this solution. The limit to the concavity extension is the tube deformation which must not be excessive to avoid failures. In fact, it is necessary to respect the minimum bending radii dictated by the absolute dimensions of the tube and the material used.

Furthermore, an excessively deep concavity 9 can increase the hydraulic resistance of the fluid flowing in the tubes of the coils 2, as it reduces its passage section. To limit the increase in hydraulic resistance, the depth of the concavity 9 must be evaluated for each specific application. The hydraulic resistance is a function of the passage section. Such resistance impacts on the boiler flow rate and on the choice of circulator. The depth of the concavity is optimised based on a cost/benefit evaluation.

In other embodiments, the first spiral heat exchanger 1 can have a different section from the pentagonal or quasi-pentagonal one described, for example it may have a circular or triangular section, provided that it has said depression 9 at least in correspondence with the combustion zone 13.

In variant embodiments of the boiler 10 according to the invention, the exchangers 1, 1′ can be surrounded by a slotted jacket 18 in correspondence with the combustion zone 13 and/or the condensation zone 14.

By slotted jacket is meant a bulkhead provided with openings, for example slots and/or holes. Such a slotted jacket 18 can be provided externally to the heat exchanger arranged in a serpentine manner in the combustion zone and can be arranged in correspondence with the condensation zone, both internally and/or externally to the heat exchangers

The openings of the bulkheads are preferably positioned between two consecutive coils, in this way, the heat exchange and the circulation of the fumes are considerably improved.

In particular, FIG. 10 shows the slotted jacket 18 in correspondence with the combustion zone 13, and FIGS. 11a and 11c show it also in correspondence with the condensation zone 14.

Again, as shown in FIGS. 11a and 11b, a second slotted jacket 19 may be provided, arranged internally to the heat exchangers 1, 1′, in particular surrounded by them, in correspondence with the condensation zone 14.

In the variant of FIG. 11a both slotted jackets are provided, an external one 18 and an internal one 19, while in the variant of FIG. 11b there is only the internal slotted jacket 19.

In correspondence with the combustion zone 13, the openings of the slotted jacket 18 or 19 can be constant or variable to balance the passage of the flow of combustion fumes between the internal exchanger 1 and the external exchanger 1′, thus balancing and optimising the heat exchange.

Having variable openings results in a balance of the passage of combustion fumes and therefore in a better heat exchange.

The balance of the openings is a function not only of the heat exchanger but also of the structure and distribution of the burner.

The solution according to the invention is integrated into a condensing boiler, however it can also be provided in boilers that only have a combustion zone, maintaining the technical advantages of the present invention. Therefore, it can be integrated into a boiler that is not necessarily a condensing boiler, which provides for the heating of liquids, for example domestic hot water.

Advantageously, thanks to the solution according to the invention, the oxidation times of the CO into CO₂ are lengthened, reducing the number of polluting agents produced.

Again, thanks to the present invention, the phenomenon of the formation of flaking of the material which makes up the surface of the exchanger in the combustion zone is reduced.

In the foregoing the preferred embodiments have been described and variants of the present invention have been suggested, but it should be understood that those skilled in the art will be able to make modifications and changes without thereby departing from its scope of protection, as defined by the attached claims.

1-11. (canceled)

12. A boiler, comprising:
at least one combustion zone;
a burner arranged in correspondence with the combustion zone along a longitudinal axis; and
at least one first heat exchanger that encircles the burner with an internal portion thereof facing towards the burner and directly exposed to a flame of the burner, when in use;
wherein the at least one first heat exchanger provides a steel conduit having a spiral profile and including a plurality of coils having a common axis of symmetry;
wherein the common axis of symmetry of the at least one first heat exchanger coinciding with the longitudinal axis of the boiler;
wherein the internal portion facing towards the common axis of symmetry of each coil of the first heat exchanger has a continuous depression along a portion of the spiral profile at least in correspondence with the combustion zone of the boiler.

13. The boiler according to claim 12, wherein a cross-section of the steel conduit of each steel coil of the at least one first heat exchanger has a concavity defined by two inflection points arranged at the internal portion of the coil.

14. The boiler according to claim 13, wherein a depth of the concavity is between 4% and 50% of a width of the cross-section of the steel conduit of the respective steel coil.

15. The boiler according to claim 13, wherein a height of the concavity is between 43% and 81% of a height of the cross-section of the steel conduit of the respective coil, wherein the height of the concavity is measured as a distance between the two inflection points.

16. The boiler according to claim 13, wherein a cross-section of the steel conduit of each coil has two opposite and parallel sides, which are substantially transverse to the common axis of symmetry, such as to form a plurality of parallel channels between adjacent coils.

17. The boiler according to claim 13, wherein a cross-section of the steel conduit of each coil is circular, triangular or almost-pentagonal and the cross-section has an internal side which comprises the concavity.

18. The boiler according to claim 12, further comprising a second heat exchanger that provides a conduit having a spiral profile and includes a plurality of coils whose axis of symmetry coincides with the longitudinal axis, the coils of the second heat exchanger having a greater radius than the radius of the coils of the at least one first heat exchanger so as to externally encircle the at least one first heat exchanger.

19. The boiler according to claim 18, wherein each coil of the second heat exchanger is arranged between two coils of the at least one first heat exchanger so as to mutually interpenetrate and form additional channels for the passage of the combustion fumes.

20. The boiler according to claim 19, wherein a cross-section of the steel conduit of each coil of the first heat exchanger and of the second heat exchanger has an edge having an acute angle between 30° and 90°, the edge of each coil of each heat exchanger being faced towards the gap between two adjacent coils of the other heat exchanger.

21. The boiler according to claim 19, a cross-section of the steel conduit of each coil of the second heat exchanger has the same shape as the cross-section of the steel conduit of each coil of the first heat exchanger mirrored with respect to an imaginary plane, parallel to the longitudinal axis

22. The boiler according to claim 12, wherein the boiler is a condensing boiler including a condensation zone adjacent along the longitudinal axis to the combustion zone and separated from it by an internal separation part.
